(19) United States
(12) Patent Application Publication
(10) Pub. No.: US 2014/0038649 A1
(43) Pub. Date: Feb. 6, 2014

(54) Connection System and Method to Dynamically Create and Collect a Group of Contextual Contacts

(71) Applicant: Bizzingo, Inc, (US)

(72) Inventors: Jeffrey S. Kirschner, Oakland, CA (US); Mark A. McCabe, Point Richmond, CA (US); Ronald Bouganim, San Francisco, CA (US)

(73) Assignee: BIZZINGO, INC, Flemington, NJ (US)

(21) Appl. No.: 13/777,855

(22) Filed: Feb. 26, 2013

Related U.S. Application Data
(63) Continuation of application No. 13/546,869, filed on Jul. 11, 2012, now abandoned.
(60) Provisional application No. 61/506,574, filed on Jul. 11, 2011.

(51) Int. Cl. H04W 4/14

(52) U.S. Cl. CPC H04W 4/14
USPC 455/466

(57) ABSTRACT

An invention is provided in the technical field of network communication more particularly; the present invention is in the technical field of communications architecture, and a communications agent that works as software on and across computing devices for the creation and collection of a communication group of contextual contacts.

### CROSS-REFERENCE TO RELATED APLICATION

This application is a continuation (and claims the benefit of priority under 35 USC 120) of U.S. application Ser. No. 13/546,869, filed Jul. 11, 2012, which claims the benefit to U.S. Provisional Application Ser. No. 61/506,574, filed on Jul. 11, 2011. Both of these prior applications are incorporated by reference in their entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of network communication more particularly; the present invention is in the technical field of communications architecture, and a communications agent that works as software on and across computing devices for the creation and collection of a communication groups.

Public speakers such as presenters, hosts, panelist, and moderators generally follow up with interested audience participants post presentation. Currently they do this in several ways, they talk to audience participants directly after presenting, and/or they display their contact information such as name, phone number, email address, skype name, instant message id, twitter handle or other common networking tools. This presents a problem of organizing contact information, relationship management and follow up. Public speakers are left with random business card, anonymous phone numbers, email box overload, and unidentified people trying to contact them with out context.

Clearly, there is a need in the art for a method of bypassing all of these confusing processes in to a simple process for a communications device to web based service that simplifies public speakers hardship.

### SUMMARY OF THE INVENTION

The present invention relates to a communication architecture and method for dynamically creating and collecting a group of contextual contacts based on an event. The method includes gathering data for an event and assigning a unique code to the event. The method further utilizes the code with a text chatting function found on communication devices such as a mobile phone. The communication device uses the text chatting function to send the event code through mobile service providers' common short code and SMS network to a networked server response agent apparatus.

In one arrangement of the response agent apparatus the response agent identifies the event code that an event was assigned to and produces a dynamic response message to the inbound common short code message, further more the response agent uses an integrated mobile service providers common short code platform to send the dynamic response back message to the originating communications device.

The present invention also relates to back to the communication devices where the dynamic response message is received through SMS. The response message SMS is viewed with a common communication device SMS interface apparatus. The response message contains and actionable instruction to the user. In one arrangement of the actionable instruction a URL is presented. In further detail, taking action on the URL with SMS interface apparatus, the communication device presents an apparatus that includes a user interface where information is presented, collected, submitted and stored in a network based database.

The present invention also relates to the identified contact information or contacts through the mobile service providers SMS platform and collected data collected thought the communication devices and user interface apparatus. In one arrangement of the collected data a processor apparatus combines the contact information identified in the mobile service providers SMS interface apparatus, the collected data from the communication device user interface apparatus and associated unique event code and stores them in a networked database.

The present invention also relates to an apparatus that includes a user interface and digital data processor for information storage and retrieval from the networked database, the user interface apparatus also reads, updates and/or deletes data from the data store.

### BRIEF DESCRIPTION OF THE DRAWINGS

Preferred embodiments of the present invention are hereinafter described, by way of example only, with reference to the accompanying drawings, wherein:

FIG. 1 is a flowchart that is useful for understanding the present invention;

FIG. 2 is a flowchart that is useful for understanding the present invention;

FIG. 3 is a flowchart that is useful for understanding the present invention;

FIG. 4 is a flowchart that is useful for understanding the present invention;

FIG. 5 is a flowchart that is useful for understanding the present invention; and

FIG. 6 represents a diagram of a conference that is useful for understanding the present invention.

### DETAILED DESCRIPTION OF THE OF PREFERRED EMBODIMENT OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

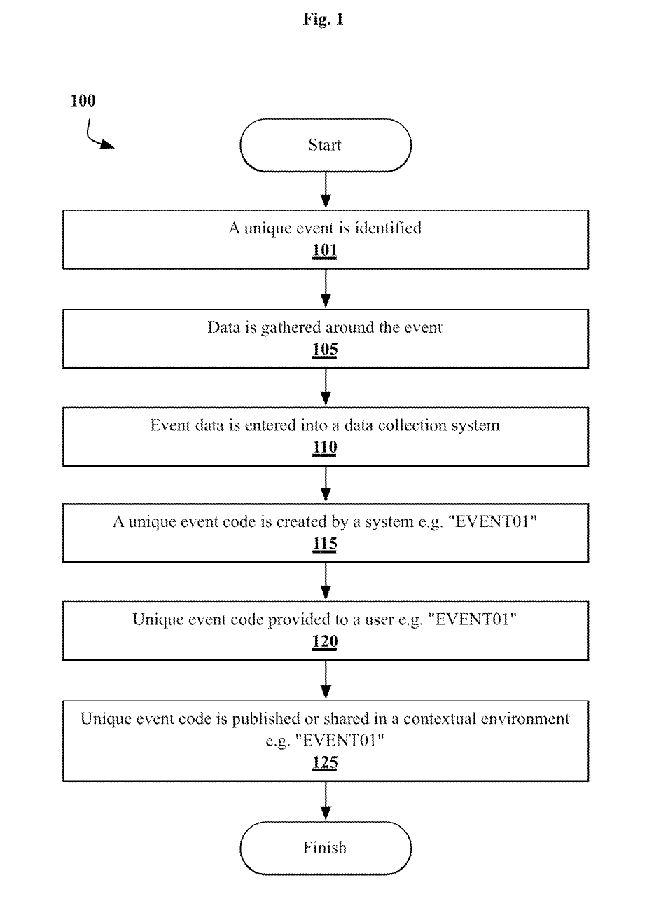

Referring now to the invention in more detail, in FIG. 1 there is shown a block flow chart representing 100 the collection, creation and publication of a unique event code. In more detail, still referring to the invention of FIG. 1 where 101 a unique event is identified or created, e.g. a conference or presentation. Further more specific 105 data is gathered around the event. In more detail, still referring to the invention of FIG. 1 the collected 105 event data is digitally entered into a 110 data collection system via a user interface.

In further detail, still referring to the invention of FIG. 1 a 115 unique event code associated with the 101 event and the 105 event data gathered is created. In more detail, still referring to the invention of FIG. 1 where the unique event code is 120 provided to the a user. In more detail, still the user now takes the 115 unique event code and announces, publishes or shares with a 125 contextual environment.

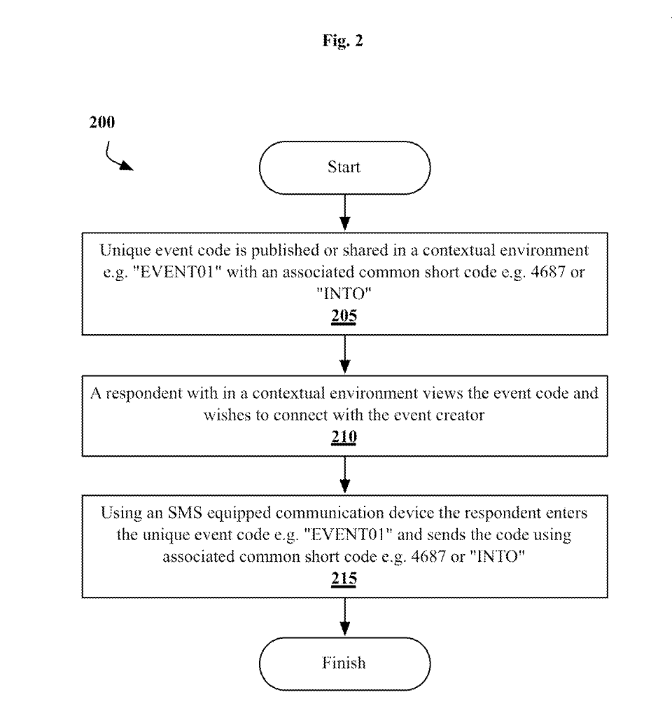

Referring now to the invention in more detail, in FIG. 2 there is shown a block flow chart representing 200 where the 205 unique event code is announced, published or shares with a common short code with a contextual environment. In further detail, still referring to the invention of FIG. 2 where as a 210 responder with in the contextual environment views the 205 unique event code and wishes to respond to the event. In more detail, still referring to the invention of FIG. 1 where the 210 respondent now uses the 205 event code in combination with 205 common short code with a 215 SMS equipped communication device to send the 205 unique event code via a mobile service providers common short code and SMS network.

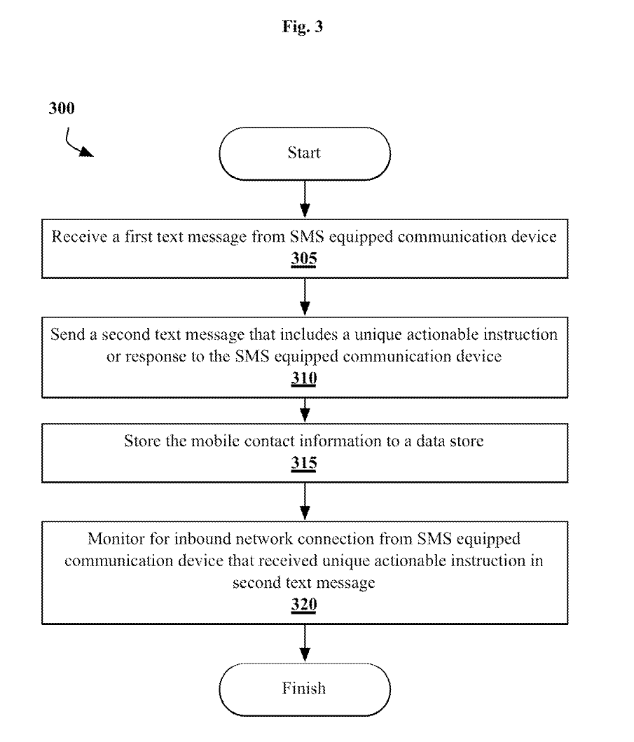

Referring now to the invention in more detail, in FIG. 3 there is shown a block flow chart representing 300 a dynamic response agent and system, where the system 305 receives a first text message from a SMS equipped communication device. In more detail, still referring to the invention of FIG. 3 the 305 dynamic response agent and system send a second text message that includes a 310 unique actionable instruction or response to the SMS equipped communication device.

In further detail, still referring to the invention in FIG. 3 a 315 dynamic response agent and system processor stores the contact information that the mobile service providers common short code and SMS network supplied into a data store along now with unique event code. In more detail, still referring to the invention of FIG. 3 a 320 monitoring process is now initiated to look for in inbound network connection from the SMS equipped communication device that received unique actionable instruction in second text message.

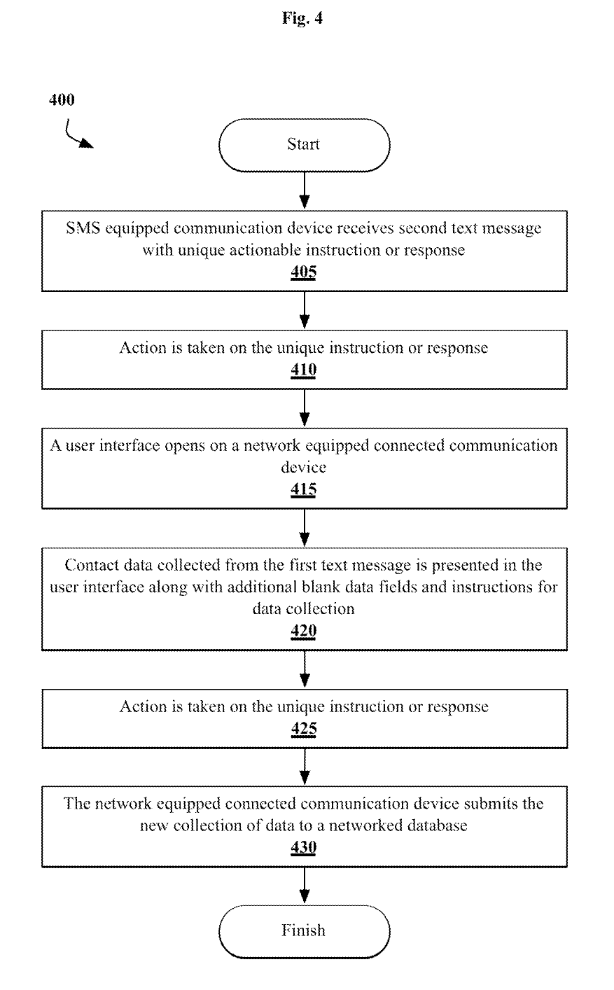

Referring now to the invention in more detail, in FIG. 4 there is shown a block flow chart representing 400 a users response to the second text message that includes a unique actionable instruction or response, where as a 405 SMS equipped communication device receives the second text message. In more detail, still referring to the invention of FIG. 1 user initial 410 action is taken on 405 unique actionable instruction, where as a 415 user interface hosted on a network equipped communication device exposed.

In further detail, still referring to the invention of FIG. 4 the 420 contact data collected from the first text message is presented in the user interface along with additional blank data fields and instructions for data collection. In still more detail, still referring to the invention of FIG. 1 user 425 action is taken on the unique instruction or response and addition contact data is inserted using the interface of 415 network equipped connected communication device.

In further detail, still referring to the invention of FIG. 1 where the user elects to 430 submit the new collection of data to a networked database via the network equipped connected communication device.

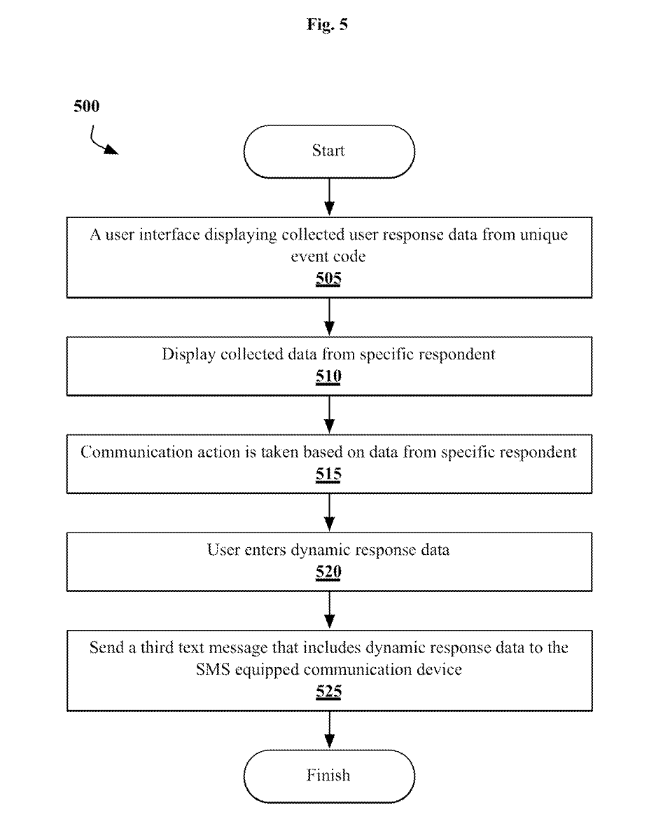

Referring now to the invention in more detail, in FIG. 5 a 500 communication user interface, where as a 505 user interface displays the combined contextual collected user response data for the unique event code including but not limited to the information collected from, referring now to the invention in more detail, in FIG. 3 information gathered from 315 the contact information the mobile service providers common short code and SMS network interface supplied in the form of users first and last name, and communication device identifier and, referring now to the invention in more detail, in FIG. 4 information gathered from the 430 submitted user interface data on the 415 network equipped connected communication device.

In further detail, still referring to the invention of FIG. 5 the 500 display of the unique collected date from 510 specific respondent. In more detail, still referring to the invention of FIG. 5 where in 520 user enters dynamic response data into a communication user interface and elects a submit.

Referring now to the invention in more detail, in FIG. 5 a 500 communication user interface, where as a possessor and system 525 send a third text message that includes 520 user entered dynamic response data to the SMS equipped communication device.

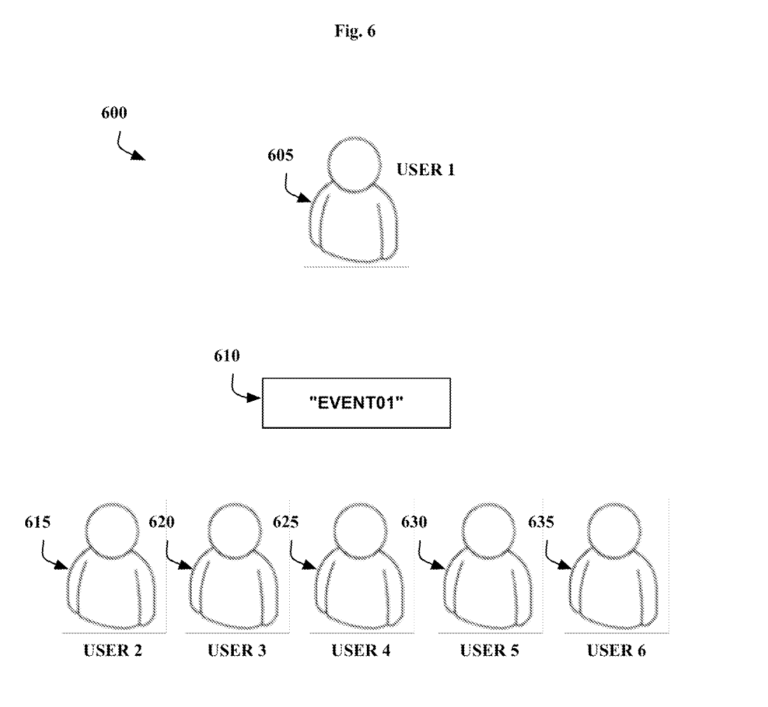

Referring now to the invention in more detail, in FIG. 6 there is shown a diagram the represents a 600 conference where 605 the presenter is 610 presenting to a set of 606 audience members. As part of the 610 presentation the presenter 605 publishes, displays, or announces a 611 unique event code to the 606 audience members. Any 615˜635 user in the 606 audience can now use an SMS equipped communication device to send the 611 unique event code via a mobile service providers common short code and SMS network.

The advantages of the present invention include, without limitation, automatically gather audience contact details, dynamically prioritize the most relevant contacts for follow ups, reduce the post-event crowd rush, replace publicly disclosing information such as name, phone number, email address, skype name, instant message id, twitter handle, and control inbox overload.

Many modifications will be apparent to those skilled in the art without departing from the scope of the present invention as hereinbefore described with reference to the accompanying drawings.

While the foregoing written description of the invention enables one skilled in the art to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method comprising:
enabling a conference administrator to distribute conference information to a user identity;
enabling the conference administrator to identify a context for the user identity;
enabling the user identity to establish a connection with an electronic conference; and
configuring, based on the context for the user identity, the electronic conference to distribute information to the user identity.
